(19) United States
(12) Patent Application Publication
(10) Pub. No.: US 2015/0160333 A1
(43) Pub. Date: Jun. 11, 2015

(54) METHOD OF CALIBRATING AN INFRASOUND DETECTION APPARATUS AND SYSTEM FOR CALIBRATING THE INFRASOUND DETECTION APPARATUS

(71) Applicant: KOREA INSTITUTE OF GEOSCIENCE AND MINERAL RESOURCES, Daejeon (KR)

(72) Inventors: Tae Sung KIM, Daejeon (KR); Il-Young CHE, Daejeon (KR)

(21) Appl. No.: 14/460,751

(22) Filed: Aug. 15, 2014

(30) Foreign Application Priority Data
Dec. 5, 2013 (KR) 10-2013-0150384

(51) Int. Cl. G01S 7/52

(52) U.S. Cl. CPC G01S 7/52004

(57) ABSTRACT

In order to calibrate an infrasound detection apparatus including a sound pressure measurement device, a background noise removal device, and a ground vibration velocity measurement device, a step of generating an artificial seismic wave using an artificial seismic source at a position that is spaced a specific distance from the sound pressure measurement device, a step of measuring an atmospheric pressure change and a ground vibration velocity caused by the artificial seismic wave, and a step of comparing the atmospheric pressure change value measured by the sound pressure measurement device with a theoretical atmospheric pressure change value may be performed.

### CROSS-REFERENCE TO RELATED APPLICATION

This application claims priority to and the benefit of Korean Patent Application No. 10-2013-0150384, filed Dec. 5, 2013, the disclosure of which is incorporated herein by reference in its entirety.

### BACKGROUND

1. Field of the Invention

The present invention relates to a method and system for calibrating an infrasound detection apparatus, which can calibrate sensitivity of the infrasound detection apparatus to a sound wave within a specific frequency range before a field measurement.

2. Discussion of Related Art

Infrasound is a sound wave having a frequency of 0.01 Hz to 20 Hz, which is below the range of human hearing. Infrasound measurement is one of the technologies that are used to globally monitor nuclear tests as a portion of the International Monitoring System (IMS), which is a monitoring system of the Comprehensive Nuclear Test Ban Treaty (CTBT), in addition to a seismic wave, a hydroacoustic wave, and radionuclides. Recently, infrasound has been used to provide critical information to studies for distinguishing an artificial blast in the ground or atmosphere from a natural earthquake, in addition to nuclear test monitoring. Research on infrasound was introduced as an important method for monitoring an atmospheric nuclear test in the 1940s and 50s and had been reduced since the Test Ban Treaty of 1963 that prohibited any nuclear explosion in the atmosphere, in outer space, and under water. However, the CTBT was opened for signature of States by the United Nations in 1996, and for global detection of a nuclear explosion, IMS has been installed. Thus, infrasound observation stations have been globally built according to a project for installing the IMS, and in recent days, much research using obtained data from the IMS is in progress internationally. Infrasound sources may include nuclear testing, a volcano explosion, meteorite movement, a typhoon, a landslide, an aurora, an earthquake, an artificial blast, a supersonic airplane, a missile launch, an atmospheric flow change in a mountainous area, and a flight vehicle in an atmosphere. Atmosphere pressure changes caused by the infrasound sources are to be observed, and an IMS infrasound measuring apparatus should be able to measure a standard volume change rate due to the atmospheric pressure to a minimum of 0.01 microbars by using a microbarometer and provide a certain response to a low frequency band of 0.01 to 20 Hz. In order to decrease noise generated by wind around an observation station, the microbarometer is connected with a special atmospheric background noise removal device. Research has been conducted to develop and arrange other atmospheric background noise removal devices having a high signal-to-noise ratio.

However, when the atmospheric background noise removal device is coupled with the microbarometer, the coupling therebetween has an influence on measurement of the atmospheric pressure change by the microbarometer, and thus a calibration should be performed before a field measurement in order to compensate for the influence.

### SUMMARY OF THE INVENTION

The present invention is directed to a simple method of calibrating an infrasound detection apparatus by using an artificial seismic source whenever necessary.

The present invention is also directed to a system for calibrating an infrasound detection apparatus according to the above calibration method.

One aspect of the present invention provides a method of calibrating an infrasound detection apparatus including a sound pressure measurement device, a background noise removal device coupled to the sound pressure measurement device, and a ground vibration velocity measurement device disposed adjacent to the sound pressure measurement device. The method may include: generating an artificial seismic wave by using an artificial seismic source at a position that is spaced a first distance from the sound pressure measurement device; measuring an atmospheric pressure change and a ground vibration velocity that are caused by the artificial seismic wave by using the sound pressure measurement device and the ground vibration velocity measurement device; and comparing the measured atmospheric pressure change value with a theoretical atmospheric pressure change value that is calculated based on the measured ground vibration velocity, an atmospheric density, and a sonic velocity to calibrate measurement sensitivity of the infrasound detection apparatus.

The theoretical atmospheric pressure change value may be calculated using the following equation:

ΔP=ρcV,

where ΔP is a theoretical atmospheric pressure change value, V is a ground vibration velocity that is measured by the ground vibration velocity measurement device 130, and ρ and c are a theoretical atmospheric density and a theoretical sonic velocity when measured, respectively.

The artificial seismic source may be provided at a position where the ground vibration velocity measured by the ground vibration velocity measurement device is equal to a predetermined target value of the ground vibration velocity. The target value of the ground vibration velocity may be about 0.5 cm/s to about 5 cm/s inclusive.

The separation distance between the artificial seismic source and the sound pressure measurement device or an amplitude of the artificial seismic wave may be changed such that the ground vibration velocity measured by the ground vibration velocity measurement device is equal to the target value of the ground vibration velocity.

The calibration of the measurement sensitivity of the sound pressure measurement device may be performed on a measurement of a sound wave having a frequency within 1 to 10 Hz, and the artificial seismic source may generate the artificial seismic wave having a frequency that is swept between a lower limit frequency which is equal to or less than 1 Hz and an upper limit frequency which is equal to or greater than 10 Hz.

The calibration of the measurement sensitivity of the sound pressure measurement device may be performed on a measurement of a sound wave having a frequency within 3 to 10 Hz, and the artificial seismic source may generate the artificial seismic wave having a frequency that is swept between a lower limit frequency which is equal to or less than 3 Hz and an upper limit frequency which is equal to or greater than 10 Hz.

Another aspect of the present invention provides a system for calibrating an infrasound detection apparatus including a sound pressure measurement device, a background noise removal device coupled to the sound pressure measurement device, and a ground vibration velocity measurement device disposed adjacent to the sound pressure measurement device, the system including: an artificial seismic source control unit configured to control an operation of the artificial seismic source such that the artificial seismic source generates an artificial seismic wave having a constant amplitude and a predetermined range of frequencies that are continuously changed during a certain period of time; a distance setting unit configured to compare a ground vibration velocity measured by the ground vibration velocity measurement device with a predetermined target value to determine whether a difference between the measured ground vibration velocity and the target value is within a tolerance range; and a sensitivity calibration unit configured to compare a theoretical atmospheric pressure change value calculated based on the ground vibration velocity measured by the ground vibration velocity measurement device, an atmospheric density, and a sonic velocity to an atmospheric pressure change value measured by the sound pressure measurement device to calibrate measurement sensitivity of the infrasound detection device upon determining that the difference between the measured ground vibration velocity and the target value is within a tolerance range.

The tolerance range may be set to be within 5% of the target value.

The sensitivity calibration unit may include a theoretical value calculation unit configured to calculate the theoretical atmospheric pressure change value; and a compensation unit configured to compare the theoretical atmospheric pressure change value with the atmospheric pressure change value measured by the sound pressure measurement device to compensate for the measurement sensitivity of the infrasound detection apparatus. The theoretical value calculation unit may include: a memory configured to store data on an atmospheric density and a sonic velocity measured at a temperature and humidity; and a calculator configured to receive information on the atmospheric density and a sonic velocity corresponding to the measured temperature and humidity from the memory based on information on temperature and humidity measured by an external temperature and humidity measurement device and calculating the theoretical atmospheric pressure change value using the equation based on the information on the ground vibration velocity measured by the ground vibration velocity measurement device and the information on the sonic density and the sonic velocity. When the difference between the ground vibration velocity and the target value is within the tolerance range, the distance setting unit may provide, to the calculator, the information on the ground vibration velocity measured and provided by the ground vibration velocity measurement device, and the calculator may calculate the theoretical atmospheric pressure change value using the information on the ground vibration velocity provided by the distance setting unit.

When the ground vibration velocity is less than the target value to the extent of being outside of the tolerance range, the distance setting unit may control an operation of the artificial seismic source control unit to increase an amplitude of an artificial seismic wave generated by the artificial seismic source. When the ground vibration velocity is greater than the target value to the extent of being outside of the tolerance range, the distance setting unit may control an operation of the artificial seismic source control unit to decrease an amplitude of an artificial seismic wave generated by the artificial seismic source.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a view illustrating a method of calibrating an infrasound detection apparatus using an artificial seismic source according to an embodiment of the present invention;

FIG. 2 is a flowchart illustrating the method of calibrating the infrasound detection apparatus; and

FIG. 3 is a block diagram illustrating a system for calibrating an infrasound detection apparatus according to an embodiment of the present invention.

### DETAILED DESCRIPTION OF EMBODIMENTS

Hereinafter, an embodiment of the present invention will be described in detail with reference to the accompanying drawings. Since the present invention may be variously modified and have several exemplary embodiments, specific exemplary embodiments will be shown in the accompanying drawings and be described in detail in a detailed description. However, it is to be understood that the present invention is not limited to the specific exemplary embodiments, but includes all modifications, equivalents, and substitutions included in the spirit and the scope of the present invention. Like reference numerals refer to like elements throughout. In accompanying drawings, dimensions may be exaggerated for clarity of illustration.

In the following description, the technical terms are used only for explaining a specific exemplary embodiment while not limiting the present disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or a combination thereof.

Unless otherwise defined, all terms (including technical and scientific terms) used herein have the same meaning as commonly understood by one of ordinary skill in the art to which this invention belongs. Terms that are generally used and have been in dictionaries should be construed as having meanings matched with contextual meanings in the art. In this description, unless defined clearly, terms are not ideally, excessively construed as formal meanings.

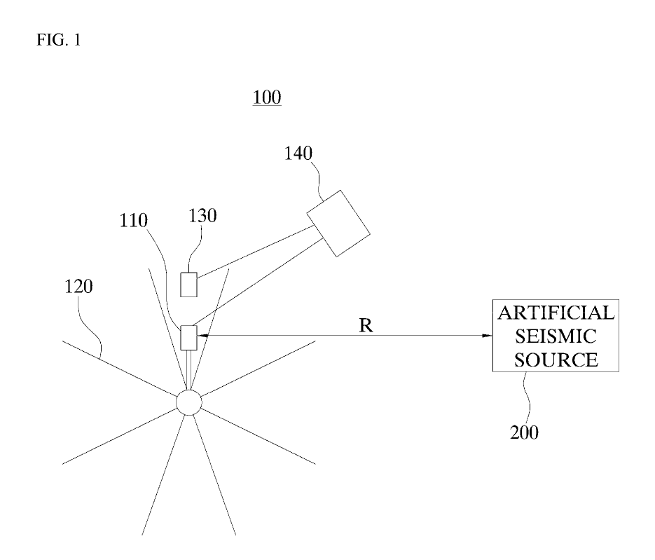

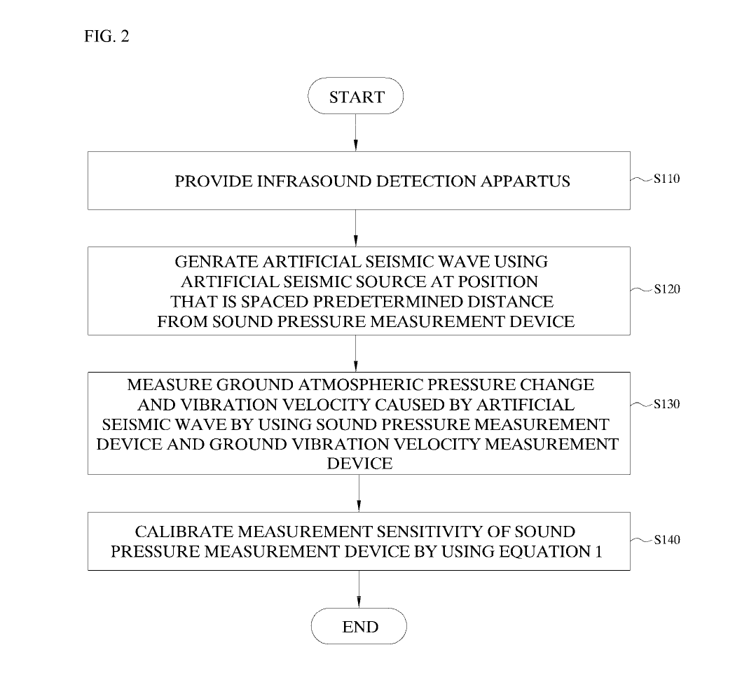

FIG. 1 is a view illustrating a method of calibrating an infrasound detection apparatus using an artificial seismic source according to an embodiment of the present invention, and FIG. 2 is a flowchart illustrating the method of calibrating the infrasound detection apparatus.

An infrasound detection apparatus 100 to be calibrated according to an embodiment of the present invention includes a sound pressure measurement device 110, a background noise removal device 120, and a ground vibration velocity measurement device 130.

The sound pressure measurement device 110 measures atmospheric pressure changes caused by infrasound. Any known pressure sensor may be used as the sound pressure measurement device 110. As an example, a known barometer may be used as the sound pressure measurement device 110.

The background noise removal device 120 is connected to the sound pressure measurement device 110 to reduce noise produced by an external environment such as wind. The background noise removal device 120 includes a plurality of hoses or pipes that are arranged radially with respect to the sound pressure measurement device 110 on the ground. In general, each of the plurality of hoses or pipes included in the background noise removal device 120 has a length of about 8 m or more.

The ground vibration velocity measurement device 130 is positioned adjacent to the sound pressure measurement device 110 and configured to measure a ground vibration velocity at that position. Here, the term “ground vibration velocity” refers to a distance that any one point on the ground travels per unit of time due to vibration of the ground. The ground vibration velocity measurement device 130 may include, but is not limited to, a known seismograph.

The infrasound detection apparatus 100 needs to be calibrated before a field measurement. A method of calibrating the infrasound detection apparatus 100 may include a method of separating only the sound pressure measurement device 110 from other elements and calibrating the separated sound pressure measurement device 110. However, this method has a limitation in that accurate calibration cannot be achieved because an effect caused by a coupling with the background noise removal device 120 is not considered. The method of calibrating the infrasound detection apparatus 100 may also include a method of providing and then calibrating the entirety of the infrasound detection apparatus in a laboratory. However, this method has a limitation in that the entirety of the infrasound detection apparatus cannot be provided in the laboratory because the background noise device is long and thus the provision of the infrasound detection apparatus 100 requires a large area.

To overcome the limitations, the present invention provides a method and system for providing the infrasound detection apparatus 100 in a field and then calibrating the infrasound detection apparatus 100.

The method and system for calibrating the infrasound detection apparatus 100 according to an embodiment of the present invention may calibrate sensitivity of the infrasound detection apparatus 100 to infrasound within a specific frequency range. As an example, the method and system for calibrating the infrasound detection apparatus 100 according to an embodiment of the present invention may calibrate sensitivity to infrasound ranging from about 1 Hz to about 10 Hz. This is because, for the sound wave having a frequency of about 1 Hz or less, a signal-to-noise ratio is relatively high and the background noise removal device 120 combined to the sound pressure measurement device 110 hardly affects the detection of infrasound by the infrasound detection apparatus 100. As another example, the method and system for calibrating the infrasound detection apparatus 100 according to an embodiment of the present invention may calibrate sensitivity to infrasound ranging from about 3 Hz to about 10 Hz. This is because a calibration method using a natural seismic wave is difficult to apply to a frequency range of about 3 Hz or more since a signal having a frequency of about 3 Hz or more is hardly measured due to the natural seismic wave attenuation over a distance between an epicenter and an observation site. Also, it is not easy to generate an artificial seismic wave of 3 Hz or less by using current technology.

Referring to FIGS. 1 and 2, the method of calibrating the infrasound detection apparatus according to an embodiment of the present invention includes providing an infrasound detection apparatus 100 (S110), generating an artificial seismic wave by using an artificial seismic source 200 that is positioned at a predetermined distance R from a sound pressure measurement device 110 of the infrasound detection apparatus 100 (S120), measuring an atmospheric pressure change and a ground vibration velocity that are caused by the artificial seismic wave, by using the sound pressure measurement device 110 and the ground vibration velocity measurement device 130 (S130), and calibrating measurement sensitivity of the sound pressure measurement device 110 by using Equation 1 below (S140):

ΔP=ρcV, [Equation 1]

where ΔP is a theoretical atmospheric pressure change value, V is a ground vibration velocity that is measured by the ground vibration velocity measurement device 130, ρ and c are a theoretical atmospheric density and a theoretical sonic velocity, respectively, in consideration of temperature, humidity, and so on when measured.

Respective steps of the present invention will be described below in detail.

In the step of providing of the infrasound detection apparatus 100 (S110), a place for providing the infrasound detection apparatus 100 is not limited specifically. For example, the place where the infrasound detection apparatus 100 is provided may include a place selected to provide and operate the system 100, a place selected to calibrate the system 100, etc.

In the step of generating of an artificial seismic wave by using an artificial seismic source 200 that is positioned at a predetermined distance R from a sound pressure measurement device 110 of the infrasound detection apparatus 100 (S120), the artificial seismic source 200 may apply a mechanical vibration to a ground surface to generate an artificial seismic wave. A vibroseis may be used as the artificial seismic source 200. As an example, the artificial seismic source 200 may generate an artificial seismic wave having a certain amplitude and a frequency continuously changing within a predetermined range during a certain period of time.

As an example, in a case in which the sensitivity of the infrasound detection apparatus 100 is to be calibrated in a range between about 1 Hz and about 10 Hz, the artificial seismic source 200 may generate an artificial seismic wave such that a frequency of the artificial seismic wave may continuously change within a ranging between about 0.5 Hz and about 20 Hz during a certain period of time. As another example, in a case in which the sensitivity of the infrasound detection apparatus 100 is to be calibrated in a range between about 3 Hz and about 10 Hz, the artificial seismic source 200 may generate an artificial seismic wave such that a frequency of the artificial seismic wave may continuously change within a ranging between about 2 Hz and about 20 Hz during a certain period of time. In a lower limit frequency and an upper limit frequency of the artificial seismic wave, the artificial seismic wave may be distorted by an external environment, and also a measurement error may occur.

The separation distance R between the sound pressure measurement device 110 and the artificial seismic source 200 may be set in consideration of a characteristic of a ground medium in which an artificial seismic wave travels, a length of the background removal device 120, and an amplitude of the artificial seismic wave that is generated by the artificial seismic source 200.

As an example, the separation distance R between the sound pressure measurement device 110 and the artificial seismic source 200 may be set such that a ground vibration velocity measured by the ground vibration velocity measurement device 130 may have a specific target value. In the present invention, when a difference between the ground vibration velocity measured by the ground vibration velocity measurement device 130 and the target value is within a tolerance range, the ground vibration velocity measured by the ground vibration velocity measurement device 130 is considered as the target value. The tolerance range may be within about 5%, about 3%, or about 1% of the target value. As such, when the separation distance R between the sound pressure measurement device 110 and the artificial seismic source 200 is set such that a ground vibration velocity measured by the ground vibration velocity measurement device 130 may have a specific target value, the calibration of the measurement sensitivity of the sound pressure measurement device 110 using Equation 1 above may be facilitated.

To achieve accurate calibration on the infrasound detection apparatus 100, an amplitude of the sound wave measured by the sound pressure measurement device 110 is required to be in a range of about 2 Pascals to about 20 Pascals. In general, pc, which is a right side of the Equation 1, is about 400 Kg·m⁻²·s⁻¹. Accordingly, using Equation 1 above, the target value of the ground vibration velocity may be set in a range of about 0.5 cm/s to about 5 cm/s.

As an example, in order to set the separation distance R between the sound pressure measurement device 110 and the artificial seismic source 200 such that a ground vibration velocity measured by the ground vibration velocity measurement device 130 may have a specific target value, the artificial seismic source 200 may be provided at a position that is spaced any distance from the sound pressure measurement device 110 and configured to generate an artificial seismic wave. The distance may be about 50 m in consideration of a characteristic of a ground medium, a length of the background removal device 120, and so on. As such, when the artificial seismic wave is generated at a position that is spaced any distance from the sound pressure measurement device 110 and the ground vibration velocity measured by the ground vibration velocity measurement device 130 is different from a target value of the ground vibration velocity, the separation distance between the sound pressure measurement device 110 and the artificial seismic source 200 may be adjusted such that the ground vibration velocity measured by the ground vibration velocity measurement device 130 may be substantially equal to the target value of the ground vibration velocity. For example, when the ground vibration velocity measured by the ground vibration velocity measurement device 130 is less than the target value, the ground vibration velocity may be increased by decreasing the separation distance between the artificial seismic source 200 and the sound pressure measurement device 110. On the contrary, when the ground vibration velocity measured by the ground vibration velocity measurement device 130 is greater than the target value, the ground vibration velocity may be decreased by increasing the separation distance between the artificial seismic source 200 and the sound pressure measurement device 110. In an embodiment, whether the ground vibration velocity measured by the ground vibration velocity measurement device 130 is different from the target value of the ground vibration velocity may be determined by generating an artificial seismic wave multiple times, for example, about 10 times to about 20 times and then comparing an average value of measured ground vibration velocities with the target value of the ground vibration velocity.

Moreover, in order to perform an adjustment such that the ground vibration velocity measured by the ground vibration velocity measurement device 130 is equal to the target value of the ground vibration velocity, an amplitude of the artificial seismic wave may be adjusted independent of the distance between the artificial seismic source 200 and the sound pressure measurement device 130. For example, when the ground vibration velocity measured by the ground vibration velocity measurement device 130 is less than the target value, the ground vibration velocity may be increased by increasing the amplitude of the artificial seismic source. On the contrary, when the ground vibration velocity measured by the ground vibration velocity measurement device 130 is greater than the target value, the ground vibration velocity may be decreased by decreasing the amplitude of the artificial seismic source. However, the amplitude of the artificial seismic wave generated by the artificial seismic source 200 should be changed such that the amplitude of the sound wave measured by the sound detection apparatus 100 may be in a range of about 2 Pascals to about 20 Pascals as described above. Thus, the amplitude of the artificial seismic wave may have a limited range to perform an adjustment on the amplitude of the artificial seismic wave so that the ground vibration velocity measured by the ground vibration velocity measurement device 130 may be equal to the target value of the ground vibration velocity.

The step of measuring of an atmospheric pressure change and a ground vibration velocity that are caused by the artificial seismic wave by using the sound pressure measurement device 110 and the ground vibration speed measurement device 130 (S130) may include generating an artificial seismic wave multiple times using the artificial seismic source 200, measuring the atmospheric pressure change and the ground vibration velocity multiple times, and averaging the measured atmospheric pressure changes and ground vibration velocities to use the averaged values as a measured atmospheric pressure change and a measured ground vibration velocity, respectively. For example, the atmospheric pressure change and the ground vibration velocity may be measured about 10 times to about 20 times, and the average values may be used as the measured atmospheric pressure change and the measured ground vibration velocity, respectively.

As an example, when the separation distance between the sound pressure measurement device 110 and the artificial seismic source 200 is set such that a vibration velocity of the ground measured by the ground vibration velocity measurement device 130 is equal to the target value, the ground vibration velocity measured by the ground vibration velocity measurement device 130 may be used to determine whether an accurate measurement has been achieved. For example, when a difference between the ground vibration velocity measured by the ground vibration velocity measurement device 130 and the target value is significantly out of a tolerance range, the atmospheric pressure change measured together with the ground vibration velocity may be excluded from data for calculating the average value.

The calibrating of measurement sensitivity of the sound pressure measurement device 110 by using Equation 1 (S140) includes comparing the atmospheric pressure change measured by the sound pressure measurement device 110 with the theoretical atmospheric pressure change value calculated by using Equation 1 and calibrating the measurement sensitivity of the sound pressure measurement device by compensating for a difference in the comparison in an entire frequency range which is to be calibrated. In an embodiment of the present invention, the compensating for the difference between the measured atmospheric pressure change and the theoretical atmospheric pressure change refers to the compensating for a value measured by the sound pressure measurement device 110 such that the difference between the measured atmospheric pressure change and the theoretical atmospheric pressure change may be within a tolerance range.

In the calibration of the infrasound detection apparatus according to an embodiment of the present invention, after providing in a field, the system may be calibrated. Therefore, the system may be accurately calibrated. In addition, since the calibration may be performed using an artificial seismic wave, calibrating the system may be performed by a simple method at a convenient time.

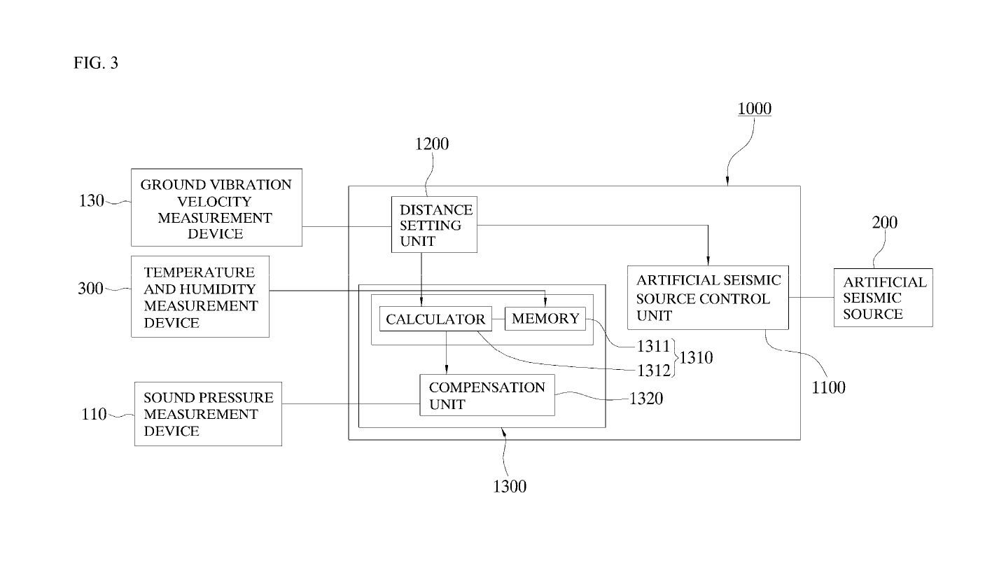

FIG. 3 is a block diagram illustrating a system for calibrating an infrasound detection apparatus according to an embodiment of the present invention.

Referring to FIGS. 1 and 3, a system 1000 for calibrating an infrasound detection apparatus according to an embodiment of the present invention includes an artificial seismic source control unit 1100, a distance setting unit 1200, and a sensitivity calibration unit 1300.

The artificial seismic source control unit 1100 may control an operation of the artificial seismic source 200. In an embodiment of the present invention, the artificial seismic source control unit 1100 may control an operation of the artificial seismic source 200 such that the artificial seismic source 200 may generate an artificial seismic wave having a constant amplitude and a predetermined frequency range in which a frequency may change continuously during a certain period of time. As an example, when the calibration is performed on the infrasound detection apparatus 100 in a range of about 1 Hz to about 10 Hz, the artificial seismic source control unit 1100 may control the artificial seismic source 200 to generate an artificial seismic wave having a frequency continuously changing in a range of about 0.5 Hz to about 20 Hz. As an example, when the calibration is performed on the infrasound detection apparatus 100 in a range of about 1 Hz to about 10 Hz, the artificial seismic source control unit 1100 may control the artificial seismic source 200 to generate an artificial seismic wave having a frequency continuously changing in a range of about 0.5 Hz to about 20 Hz.

The distance setting unit 1200 compares a ground vibration velocity measured by the ground vibration velocity measurement device 130 with a predetermined target value, and when a difference between the ground vibration velocity and the target value is within a tolerance range, controls the sensitivity calibration unit 1300 such that the sensitivity calibration unit 1300 may calibrate sensitivity of the infrasound detection apparatus 100. As an example, the distance setting unit 1200 may provide information on the ground vibration velocity measured by the ground vibration velocity measurement device 130 to the sensitivity calibration unit 1300 when the difference between the ground vibration velocity and the target value is within the tolerance range.

In an embodiment of the present invention, the distance setting unit 1200 may control an operation of the artificial seismic source control unit 1100 to increase an amplitude of the artificial seismic wave generated by the artificial seismic source 200 when the ground vibration velocity is less than the target value to the extent of being outside of the tolerance range. On the contrary, the distance setting unit 1200 may control an operation of the artificial seismic source control unit 1100 to decrease an amplitude of the artificial seismic wave generated by the artificial seismic source 200 when the ground vibration velocity is greater than the target value to the extent of being out of the tolerance range.

The sensitivity calibration unit 1300 may calibrate sensitivity of the infrasound detection apparatus 100 when the distance setting unit 1200 determines that the difference between the ground vibration velocity and the target value is within the tolerance range. As an example, the sensitivity calibration unit 1300 may calibrate sensitivity of the infrasound detection apparatus 100 when information on the ground vibration velocity is provided from the distance setting unit 1200.

In an embodiment of the present invention, the sensitivity calibration unit 1300 may include a theoretical value calculation unit 1310 and a compensation unit 1320.

The theoretical value calculation unit 1310 may include a memory 1311 and a calculator 1312. The memory 1311 may store data on an atmospheric density and a sonic velocity with temperature and humidity, respectively, and provide information on the atmospheric density and the sonic velocity corresponding to temperature and humidity on the basis of the information on the temperature and the humidity that are measured by an external temperature and humidity measurement device 300. The calculator 1312 may calculate a theoretical atmospheric pressure change value on the basis of the information on the atmospheric density and the sonic velocity corresponding to the temperature and the humidity that are provided by the memory 1311 and the ground vibration velocity that is measured by the ground vibration velocity measurement device 130. In an embodiment, the calculation unit 1312 may calculate the theoretical atmospheric pressure change value by using Equation 1.

The compensation unit 1320 may compare the theoretical atmospheric pressure change value calculated by the theoretical value calculation unit 1310 with the atmospheric pressure change value measured by the sound pressure measurement device 110 to calibrate sensitivity of the infrasound detection apparatus 100. In an embodiment, the compensation unit 1320 may calibrate the sensitivity of the infrasound detection apparatus 100 by compensating for a difference between the theoretical atmospheric pressure change value and the measured atmospheric pressure change value in an entire frequency range which is to be calibrated. As described above, the compensating for a difference between the theoretical atmospheric pressure change value and the measured atmospheric pressure change value denotes calibrating the value measured by the sound pressure measurement device 110 such that the difference between the measured atmospheric pressure change value and the theoretical atmospheric pressure change may be within a tolerance range.

According to an embodiment of the present invention, the infrasound detection apparatus may be provided in a field and then data is measured and compensated, thus performing accurate calibration, and the calibration may be performed using an artificial seismic wave, thus calibrating the system simply.

While the example embodiments of the present invention and their advantages have been described in detail, it should be understood that various changes, substitutions, and alterations may be made herein without departing from the scope of the invention.

What is claimed is:

1. A method of calibrating an infrasound detection apparatus including a sound pressure measurement device, a background noise removal device coupled to the sound pressure measurement device, and a ground vibration velocity measurement device disposed adjacent to the sound pressure measurement device, the method comprising:
generating an artificial seismic wave by using an artificial seismic source at a position that is spaced a first distance from the sound pressure measurement device;
measuring an atmospheric pressure change and a ground vibration velocity that are caused by the artificial seismic wave by using the sound pressure measurement device and the ground vibration velocity measurement device; and
comparing the measured atmospheric pressure change value with a theoretical atmospheric pressure change value that is calculated based on the measured ground vibration velocity, an atmospheric density, and a sonic velocity to calibrate measurement sensitivity of the infrasound detection apparatus.

2. The method of claim 1, wherein the theoretical atmospheric pressure change value is calculated using the following equation:
ΔP=ρcV,
where ΔP is a theoretical atmospheric pressure change value, V is a ground vibration velocity that is measured by the ground vibration velocity measurement device, and ρ and c are a theoretical atmospheric density and a theoretical sonic velocity when measured.

3. The method of claim 1, wherein the artificial seismic source is provided at a position where a ground vibration velocity measured by the ground vibration velocity measurement device is equal to a predetermined target value of the ground vibration velocity.

4. The method of claim 3, wherein the target value of the ground vibration velocity is 0.5 cm/s to 5 cm/s inclusive.

5. The method of claim 3, wherein a separation distance between the artificial seismic source and the sound pressure measurement device or an amplitude of the artificial seismic wave is changed such that the ground vibration velocity measured by the ground vibration velocity measurement device is equal to the target value of the ground vibration velocity.

6. The method of claim 1, wherein the calibration of the measurement sensitivity of the infrasound detection apparatus is performed on a measurement of a sound wave having a frequency within 1 to 10 Hz, and
wherein the artificial seismic source generates the artificial seismic wave having a frequency that is swept between a lower limit frequency which is equal to or less than 1 Hz and an upper limit frequency which is equal to or greater than 10 Hz.

7. The method of claim 1, wherein the calibration of the measurement sensitivity of the infrasound detection apparatus is performed on a measurement of a sound wave having a frequency within 3 to 10 Hz, and
wherein the artificial seismic source generates an artificial seismic wave having a frequency that is swept between a lower limit frequency which is equal to or less than 3 Hz and an upper limit frequency which is equal to or greater than 10 Hz.

8. A system for calibrating an infrasound detection apparatus including a sound pressure measurement device, a background noise removal device coupled to the sound pressure measurement device, and a ground vibration velocity measurement device disposed adjacent to the sound pressure measurement device, the system comprising:
an artificial seismic source control unit configured to control an operation of the artificial seismic source such that the artificial seismic source generates an artificial seismic wave having a constant amplitude and a predetermined range of frequencies that are continuously changed during a certain period of time;
a distance setting unit configured to compare a ground vibration velocity measured by the ground vibration velocity measurement device with a predetermined target value to determine whether a difference between the measured ground vibration velocity and the target value is within a tolerance range; and
a sensitivity calibration unit configured to compare a calculated theoretical atmospheric pressure change value based on the ground vibration velocity measured by the ground vibration velocity measurement device, an atmospheric density, and a sonic velocity to an atmospheric pressure change value measured by the sound pressure measurement device to calibrate measurement sensitivity of the infrasound detection device upon determining that the difference between the measured ground vibration velocity and the target value is within the tolerance range.

9. The system of claim 8, wherein the tolerance range is set to be within 5% of the target value.

10. The system of claim 8, wherein the sensitivity calibration unit comprises:
a theoretical value calculation unit configured to calculate the theoretical atmospheric pressure change value; and
a compensation unit configured to compare the theoretical atmospheric pressure change value with the atmospheric pressure change value measured by the sound pressure measurement device to compensate for the measurement sensitivity of the infrasound detection apparatus.

11. The system of claim 10, wherein the theoretical value calculation unit comprises:
a memory configured to store data on an atmospheric density and a sonic velocity measured at a temperature and humidity; and
a calculator configured to receive information on the atmospheric density and the sonic velocity corresponding to the measured temperature and humidity from the memory based on information on temperature and humidity measured by an external temperature and humidity measurement device and calculating the theoretical atmospheric pressure change value based on the information on the ground vibration velocity measured by the ground vibration velocity measurement device and the information on the sonic density and the sonic velocity, by using the following equation:
ΔP=ρcV,
where ΔP is a theoretical atmospheric pressure change value, V is a ground vibration velocity that is measured by the ground vibration velocity measurement device 130, and ρ and c are a theoretical atmospheric density and a theoretical sonic velocity when measured.

12. The system of claim 11, wherein when the difference between the ground vibration velocity and the target value is within a tolerance range, the distance setting unit provides, to the calculator, the information on the ground vibration velocity measured and provided by the ground vibration velocity measurement device, and
wherein the calculator calculates the theoretical atmospheric pressure change value using the information on the ground vibration velocity provided by the distance setting unit.

13. The system of claim 8, wherein when the ground vibration velocity is less than the target value and is out of the tolerance range, the distance setting unit controls an operation of the artificial seismic source control unit to increase an amplitude of an artificial seismic wave generated by the artificial seismic source.

14. The system of claim 8, wherein when the ground vibration velocity is greater than the target value and is out of the tolerance range, the distance setting unit controls an operation of the artificial seismic source control unit to decrease an amplitude of an artificial seismic wave generated by the artificial seismic source.
